(19) United States
(12) Patent Application Publication
(10) Pub. No.: US 2024/0182110 A1
(43) Pub. Date: Jun. 6, 2024

(54) STEERING DEVICE AND SAFE DRIVING SUPPORT SYSTEM

(71) Applicant: HONDA MOTOR CO., LTD., Tokyo (JP)

(72) Inventor: Kotaro NAKAMURA, Tokyo (JP)

(21) Appl. No.: 18/525,792

(22) Filed: Nov. 30, 2023

(30) Foreign Application Priority Data
Dec. 2, 2022 (JP) 2022-193620

(51) Int. Cl. B62D 6/10; B60W 10/20; B60W 50/14; B62D 1/04; G01V 3/08

(52) U.S. Cl. CPC B62D 6/10; B60W 10/20; B60W 50/14; B62D 1/046; G01V 3/08; B60W 2040/0818

(57) ABSTRACT

A steering device includes: a steering wheel; a torque sensor which detects steering torque; a measurement circuit which measures electrostatic capacitance of an electrode provided to the steering wheel; and a grip determination device which determines the presence/absence of gripping of a rim part of the steering wheel. The grip determination device determines that foreign material is contacting the rim part and the rim part is not being gripped, in a case of, after determining that the steering wheel is being gripped based on a measurement result for electrostatic capacitance from a measurement circuit, a state in which an absolute value for a detection value Tr_d of the steering torque is less than a predetermined torque threshold Tr_th continuing past a predetermined time threshold T_th.

This application is based on and claims the benefit of priority from Japanese Patent Application No. 2022-193620, filed on 2 Dec. 2022, the content of which is incorporated herein by reference.

### BACKGROUND OF THE INVENTION

### Field of the Invention

The present invention relates to a steering device and a safe driving support system. In more detail, it relates to a steering device and a safe driving support system which accept steering operations from a driver.

### Related Art

In recent years, endeavors have become more active to provide access to a sustainable transport system made in consideration of many people who are in a weak situation among traffic participants. Addressing the realization of this, the research and development for greatly improving the safety and convenience of traffic is given attention through the research and development related to driving aid functions such as a lane keeping function, lane departure prevention function, and preceding vehicle follow function.

With a vehicle equipped with such a driving aid function, in the case of determining the presence/absence of gripping of the steering wheel by the driver by way of a sensor device such as that shown in Patent Document 1, for example, and determining as not gripping, the driver may be prompted to grip the steering wheel, and cancelling the driving aid function during execution.

With the sensor device shown in Patent Document 1, the presence/absence of gripping of the steering wheel by the driver is determined based on the measurement value of the electrostatic capacitance of the electrodes provided to the steering wheel.
Patent Document 1: Japanese Unexamined Patent Application, Publication No. 2016-203660

### SUMMARY OF THE INVENTION

However, in the case of determining the presence/absence of gripping of a steering wheel based on the measurement value for electrostatic capacitance as in the sensor device described in Patent Document 1, if foreign material having electrostatic capacitance (for example, a wet towel, portable information terminal, beverage container or the like) is contacting the steering wheel, there is concern of misjudging as being gripped irrespective of the driver not gripping the steering wheel.

Therefore, with the sensor device described in Patent Document 1, in the case of the measurement value of electrostatic capacitance being at least a predetermined value, and the driver's heartbeat not being detected, it determines that a foreign material is contacting the steering wheel. However, in this case, it is necessary to provide a heartbeat detection device to detect the heartbeat of the driver gripping the steering wheel, and there is concern over the cost thereby increasing.

The present invention has an object of providing a steering device and a safe driving support system which can precisely detect the presence/absence of gripping of a steering wheel by the driver, while distinguishing between contact of foreign material and contact of the hand of the driver to the steering wheel.

A steering device (for example, the steering device 1 described later) according to a first aspect of the present invention includes: a steering wheel (for example, the steering wheel 2 described later) which accepts a steering operation of a vehicle by a driver; a torque sensor (for example, the torque sensor 31 described later) which detects steering torque acting on the steering wheel; a measurement device (for example, the measurement circuits 62R, 62L, 62U, 62D described later) which measures electrostatic capacitance of an electrode (for example, the electrodes 60R, 60L, 60U, 60D described later) provided to the steering wheel; and a grip determination device (for example, the grip determination device 60 described later) which determines presence/absence of gripping of the steering wheel, in which the grip determination device determines that the steering wheel is not being gripped in a case of, after determining that the steering wheel is being gripped based on a measurement result from the measurement device, a state in which an absolute value for a torque detection value (for example, the detection value Tr_d described later) from the torque sensor is less than a predetermined torque threshold (for example, the torque threshold Tr_th described later) continuing past a predetermined time threshold (for example, the time threshold T_th described later).

According to a second aspect of the present invention, in this case, it is preferable for the grip determination device to acquire a gripping position of the steering wheel based on the measurement result, and change either one or both of the torque threshold and the time threshold based on the gripping position.

A safe driving support system according to a third aspect of the present invention includes: the steering device; and a controller group (for example, the controller group 8 described later) communicably connected with the grip determination device.

According to a fourth aspect of the present invention, in this case, it is preferable for the controller group to include a notification device (for example, the notification device 81 described later) which notifies a driver of information generated based on a determination result from the grip determination device.

According to a fifth aspect of the present invention, in this case, it is preferable for the notification device to change a notification mode between a case of determining that the steering wheel is not being gripped based on the measurement result, and a case of determining that the steering wheel is not being gripped in response to the state in which the absolute value for the torque detection value is less than the torque threshold continuing past the time threshold.

According to a sixth aspect of the present invention, in this case, it is preferable for the controller group to include a safe driving ability evaluation device (for example, the safe driving ability evaluation device 82 described later) which evaluates a safe driving ability of the driver based on the determination result from the grip determination device.

According to a seventh aspect of the present invention, in this case, it is preferable for the controller group to include an automatic driving device (for example, the automatic driving device 83 described later) which executes automatic driving control according to a plurality of automatic driving levels, in which the automatic driving device changes the automatic driving level based on a determination result from the grip determination device.

According to the first aspect of the present invention, when the driver grips the steering wheel, naturally when turning right and left, but even when driving straight, a slight amount of steering torque is generated intermittently Therefore, the grip determination device determines that a foreign material having electrical capacitance is contacting the steering wheel in the case of the state in which the absolute value for the torque detection value from the torque sensor is less than the torque threshold continuing past the time threshold, after determining that the steering wheel is being gripped based on the measurement results for the electrostatic capacitance of the electrode provided to the steering wheel, i.e. case of significant steering torque not being detected over the time threshold, and determines that the steering wheel is not being gripped. Consequently, according to the present invention, it is possible to precisely determine the presence/absence of gripping of the steering wheel by the driver, while distinguishing between contact of a foreign material to the steering wheel and contact of the hand of the driver, and thus possible to contribute to the development of a sustainable transportation system. In addition, with the present invention, since there is no need to detect the heartbeat of the driver as mentioned above, it is possible to reduce the cost more than conventional.

According to the second aspect of the present invention, the magnitude of the steering torque generated in the case of the driver driving while gripping the steering wheel differs according to the gripping position of the steering wheel. Consequently, according to the present invention, it is possible to precisely distinguish between contact of foreign material to the steering wheel and contact of the hand of the driver, by changing either or both of the torque threshold and time threshold based on the gripping position of the steering wheel.

According to the third aspect of the present invention, the safe driving support system includes the steering device, and the controller group which is communicably connected with the grip determination device of this steering device. The controller group can thereby support safe driving by the driver based on the determination results for the presence/absence of gripping of the steering wheel and the determination result for the presence/absence of contact of a foreign material to the steering wheel by the grip determination device, and thus possible to contribute to the development of a sustainable transportation system.

According to the fourth aspect of the present invention, the notification device notifies the driver of information generated based on the determination result from the grip determination device. Since it is thereby possible to prompt appropriate gripping and prompt removal of foreign material to the driver, in the case of the driver not gripping the steering wheel or a case of foreign material contacting the steering wheel, for example, it is possible to support safe driving by the driver.

According to the fifth aspect of the present invention, since the notification device can prompt appropriate gripping to the driver, and prompt removal of foreign material assumed to be contacting the steering wheel to the driver, by changing the notification mode between a case of determining that the steering wheel is not being gripped based on the measurement results for electrostatic capacitance, and a case of determining that the steering wheel is not being gripped in response to the state in which the absolute value for the detection value of steering torque is less than the torque threshold continuing past the time threshold, it is possible to support safe driving by the driver.

According to the sixth aspect of the present invention, the safe driving ability evaluation device evaluates the driving skill of the driver based on the determination result from the grip determination device. Since it is thereby possible to evaluate the driving ability by distinguishing between a case of the driver not appropriately gripping the steering wheel, and a case of a foreign material contacting the steering wheel, for example, it is possible to support safe driving by the driver.

According to the seventh aspect of the present invention, the automatic driving device changes the automatic driving level based on the determination result from the grip determination device. Since it is thereby possible to change the automatic driving level by distinguishing between a case of the driver not gripping the steering wheel, and a case of a foreign material contacting the steering wheel, it is possible to support safe driving by the driver.

### BRIEF DESCRIPTION OF THE DRAWINGS

FIG. 1 is a view showing the configurations of a steering device and a safe driving support system including this steering device according to an embodiment of the present invention;

FIG. 2 is a view showing the circuit configuration of a grip sensor unit; and

FIG. 3 is a flowchart showing a specific sequence of grip determination processing.

### DETAILED DESCRIPTION OF THE INVENTION

Hereinafter, a steering device and safe driving support system according to an embodiment of the present invention will be explained while referencing the drawings.

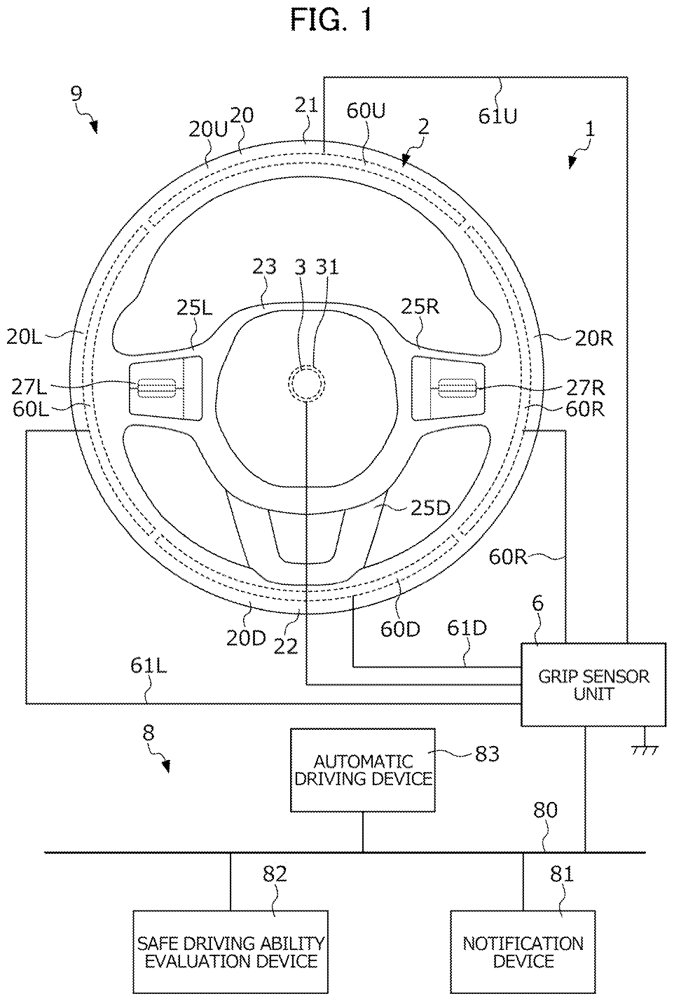

FIG. 1 is a view showing the configurations of a steering device 1 and a safe driving support system 9 including this steering device 1 according to the present embodiment.

The safe driving support device 9 includes the steering device 1 equipped to a vehicle (not shown), and a controller group 8 which is communicably connected with this steering device 1, and supports the safe driving of the vehicle by the driver by using this steering device 1 and controller group 8.

It should be noted that the present embodiment explained a case of devices 81 to 83 constituting the controller group 8 establishing an onboard device which can perform communication with the steering device 1 by CAN communication via a CAN bus 80, for example; however, the present invention is not limited thereto. All or part of the plurality of devices 81 to 83 constituting the controller group 8 may establish a vehicle external device which can communication wirelessly with the steering device 1 via an onboard communication device (not shown).

The steering device 1 includes: a steering wheel 2 which accepts steering operation of the vehicle by the driver and auxiliary device operation related to a vehicle auxiliary device; a steering shaft 3 that pivotally supports this steering wheel 2; and a grip sensor unit 6 which determines the presence/absence of gripping of the steering wheel 2 by the driver, and further acquires the gripping position thereof.

The steering wheel 2 includes a rim part 20 which can be gripped by the driver and is annular; a hub part 23 provided on the inner side of this rim part 20; and three spokes 25L, 25R, 25D connected to the inner side of the rim part 20 extending along the radial direction from the hub part 23.

The hub part 23 is cylindrical, is provided at the center of the rim part 20 viewed from the driver, for example, and configures a center of the steering wheel 2. At a back side of the hub part 23 viewed from the driver, a steering shaft 3 which pivotally supports the steering wheel 2 is coupled. The steering shaft 3 is a rod-like coupling member which couples a core, which is the backbone of the hub part 23, and a steering mechanism which constitutes part of the vehicle frame which is not shown. Therefore, the steering torque generated by the driver rotating the steering wheel 2 is transferred to the steering mechanism, which is not shown, by this steering shaft 3. In addition, a torque sensor 31 which detects the steering torque acting on the steering shaft 3, and outputs a signal according to the detection value to the grip sensor unit 6 is provided to the steering shaft 3.

The rim part 20 and hub part 23 are connected by the three spokes 25L, 25R, 25D. The left spoke part 25L extends along the horizontal direction, and connects a portion on the left side of the hub part 23 viewed from the driver, and a portion on the right side of an inner circumferential part of the rim part 20 viewed from the driver. The right sport part 25R extends in parallel with the left spoke part 25L along the horizontal direction, and connects a portion on the right side of the hub part 23 viewed from the driver, and a portion on the right side of the inner circumferential part of the rim part 20 viewed from the driver. The lower spoke part 25D extends perpendicular to the spokes 25L, 25R along the vertical direction, and connects a portion on the lower part of the hub part 23 viewed from the driver, and a portion on a lower part of the inner circumferential part of the rim part 20 viewed from the driver.

In the above way, the rim part 20 is annular viewed from the driver, and the driver can grip over the entire circumference thereof. In addition, the plurality of electrodes 60R, 60L, 60U, 60D of the grip sensor unit 6 described later are provided over the entire circumference on this rim part 20.

At the left spoke part 25L and right spoke part 25R, a left auxiliary device operation control unit 27L and a right auxiliary device operation control unit 27R which accept auxiliary device operations from the driver in order for the driver to operate vehicle auxiliary devices, which are not shown (for example, audio deice, car navigation device, etc.), are provided. The driver becomes able to operate the vehicle auxiliary devices by operating a plurality of switches provided to these auxiliary device operation control units 27L, 27R by finger.

It should be noted that, hereinafter, the positions of the substantially circular rim part 20 and steering shaft 3, and orientations of each spoke part 25L, 25R, 25D viewed from the driver may be represented by a clock-wise angle “°” centering around the steering shaft 3, and with the upper end part 21C of the rim part 20 viewed from the driver as a reference. In other words, the right spoke part 25R extends along the orientation of 90°, and connects a 90° portion of the hub part 23 and rim part 20. The lower spoke part 25D extends along an orientation of 180°, and connects a 180° portion of the hub part 23 and a 180° portion of the rim part 20, i.e. a lower end 22 of the rim part 20 viewed from the driver. In addition, the left spoke part 25L extends along the orientation of 270°, and connects a 270° portion of the hub part 23 and the rim part 20.

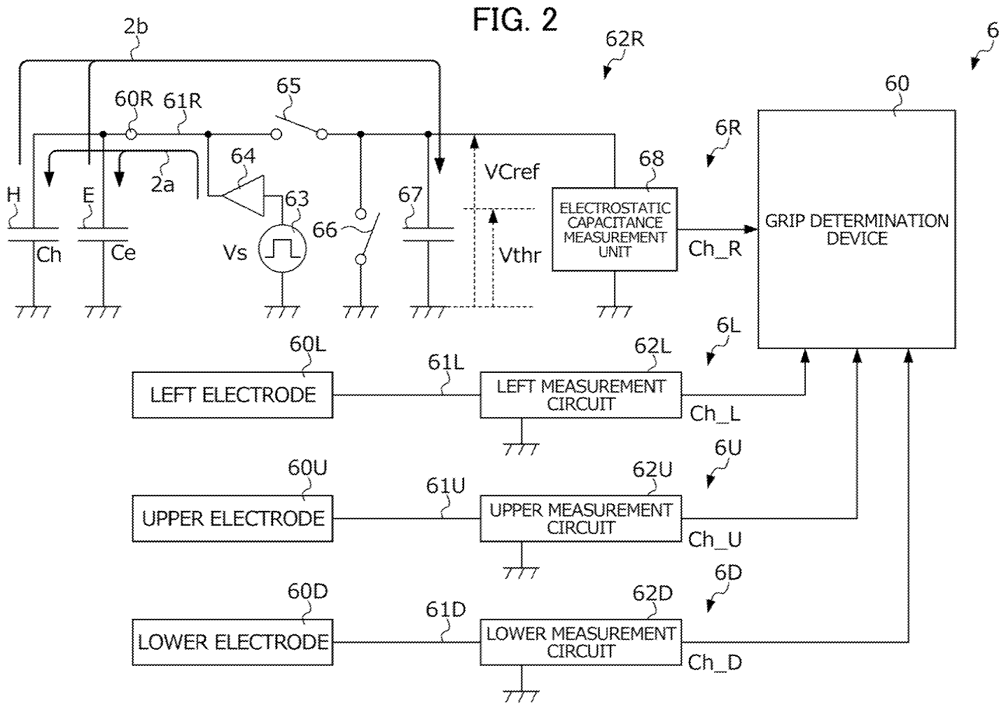

FIG. 2 is a view showing the circuit configuration of the grip sensor unit 6. The grip sensor unit 6 includes a plurality (four in the present embodiment) of proximity sensors 6R, 6L, 6U, 6D having respectively different detection target regions; and a grip determination device 60 which determines the presence/absence of gripping of the steering wheel 2 by the driver based on measurement results from these proximity sensors 6R, 6L, 6U, 6D, and further acquires the gripping positions thereof.

The right proximity sensor 6R includes a right electrode 60R provided to the rim part 20, and a right measurement circuit 62R electrically connected with this right electrode 60R. The right electrode 60R is a circular arc shape extending along the rim part 20, and is electrically conductive. The right electrode 60R is provided inside of the rim part 20. The right electrode 60R is arranged in a range of about 90° between 45° and 135° of the rim part 20 (i.e. range which can be gripped mainly by the right hand of the driver while going straight). It should be noted that, hereinafter, the region of the rim part 20 in which the right electrode 60R is arranged is also referred to as right grip 20R. The right measurement circuit 62R is connected with the right electrode 60R via a wire 61R. The right measurement circuit 62R measures electrostatic capacitance between the right electrode 60R and ground, as a value which fluctuates according to the distance between the arrangement position of the right electrode 60R and the human body. As the distance between the arrangement position of the right electrode 60R and human body narrows, the electrostatic capacitance between the right electrode 60R and ground becomes larger. A measurement value Ch_R of electrostatic capacitance by the right measurement circuit 62R is sent to the grip determination device 60.

The right measurement circuit 62R includes a pulse power source 63, amplifier 64, first switch 65, second switch 66, charge capacitor 67, and electrostatic capacitance measurement unit 68. It should be noted that FIG. 2 illustrates the electrostatic capacitance between the right electrode 60R and ground (for example, vehicle frame) to be divided into electrostatic capacitance Ch formed by the human body H including the hands of the driver operating the steering wheel 2, and the stray capacitance Ce formed by a floating capacitor E of wires, components, etc. excluding the human body H.

As shown in FIG. 2, the pulse power source 63 and amplifier 64 are connected in series. The second switch 66 and charge capacitor 67 are connected in parallel. A series circuit made from the pulse power source 63 and amplifier 64, and the parallel circuit made from the second switch 66 and charging capacitor 67 are connected via the first switch 65. An output terminal of the amplifier 64 and the first switch 65 are connected to the right electrode 60R via the wire 61R. Therefore, the pulse power source 63 is connected to the right electrode 60R via the amplifier 64 and wire 61R. In addition, the second switch 66 and charge capacitor 67 are connected to the right electrode 60R respectively via the first switch 65 and wire 61R.

The pulse power source 63 supplies a pulse voltage Vs of predetermined frequency and predetermined voltage to the amplifier 64, in response to a command from the grip determination device 60. The amplifier 64 amplifies the pulse voltage Vs supplied from the pulse power source 63, and applies it to the right electrode 60R.

The second switch 66 is a switching element which is turned ON/OFF by a drive circuit which is not illustrated. The drive circuit of this second switch 66 turns OFF the second switch 66 until the voltage VCref of the charge capacitor 67 reaches the threshold Vthr decided in advance, and turns ON the second switch 66 after the voltage VCref reaches the threshold Vthr, and discharges the charge stored in the charge capacitor 67.

The first switch 65 is a switching element which is turned ON/OFF by a drive circuit which is not illustrated. The drive circuit of this first switch 65 turns OFF the first switch 65 in response to rising of the pulse voltage Vs of the pulse power source 63. The pulse voltage supplied from the pulse power source 63 and amplifier 64 is applied to the right electrode 60R, the charge migrates through the path shown by the arrow 2a in FIG. 2, and the human body H and floating capacitor E are thereby charged.

In addition, the drive circuit of the first switch 65 turns ON the first switch 65 in response to rising of the pulse voltage Vs of the pulse power source 63. The human body H and floating capacitor E and the charge capacitor 67 are thereby connected, charge migrates through the path shown by the arrow 2b in FIG. 2 from the human body H and floating capacitor E to the charge capacitor 67, and the charge capacitor 67 is charged. The voltage VCref of the charge capacitor 67 thereby rises.

For this reason, when applying the pulse voltage to the right electrode 60R by the pulse power source 63 and amplifier 64, charge and discharge of the human body H and floating capacitor E is alternately repeated, and the voltage VCref of the charge capacitor 67 gradually increases. At this time, the time until the voltage VCref of the charge capacitor 67 reaches the threshold Vthr (or pulse number of the pulse power source 63) varies according to the static capacitance Ch formed by the human body H, i.e. distance between the right electrode 60R and body of the driver. In other words, in the case of part of the body of the driver contacting or approaching the arrangement position of the right electrode 60R on the rim part 20, and the static capacitance Ch rising, the time taken until the voltage VCref of the charge capacitor 67 reaches the threshold Vthr shortens, and in the case of part of the body of the driver distancing from the arrangement position of the right electrode 60R and the static capacitance Ch lowering, the time taken until the voltage VCref of the charge capacitor 67 reaches the threshold Vthr lengthens.

The static capacitance measurement unit 68 measures the time and pulse number until the voltage VCref of the charge capacitor 67 reaches the threshold Vthr, and measures the static capacitance Ch formed by the human body H existing in the vicinity of the right electrode 60R indirectly based on this measurement result. The static capacitance measurement unit 68 sends a measurement value Ch_R of the static capacitance Ch obtained by the above sequence to the grip determination device 60.

The left proximity sensor 6L includes a left electrode 60L provided to the rim part 20, and a left measurement circuit 62L electrically connected with this left electrode 60L. The left electrode 60L is a circular arc shape extending along the rim part 20, and is electrically conductive. The left electrode 60L is provided inside of the rim part 20. The left electrode 60L is arranged in the range of about 90° between 225° and 315° of the rim part 20 (i.e. range grippable mainly by the left hand of the driver while going straight). It should be noted that the region of the rim part 20 in which the left electrode 60L is arranged is also referred to as left grip 20L below. The left measurement circuit 62L is connected with the left electrode 60L via the wire 61L. The left measurement circuit 62L measures the static capacitance between the left electrode 60L and ground, as a value which varies according to the distance between the arrangement position of the left electrode 60L and the human body. As the distance between the arrangement position of the left electrode 60L and the human body approaches, the electrostatic capacitance between the left electrode 60L and ground increases. The measurement value Ch_L of the static capacitance by the left detection circuit 62L is sent to the grip determination device 60. It should be noted that the circuit configuration of the left measurement circuit 62L is substantially the same as the right measurement circuit 62R shown in FIG. 2, and thus detailed explanation thereof is omitted.

The upper proximity sensor U6 includes an upper electrode 60U provided to the rim part 20, and an upper measurement circuit 62U electrically connected with this upper electrode 60U. The upper electrode 60U is a circular arc shape extending along the rim part 20, and is electrically conductive. The upper electrode 60U is provided inside of the rim part 20. The upper electrode 60U is arranged in a range of about 90° between 315° and 405° (45°) of the rim part 20 (i.e. range grippable by the right hand or left hand of the driver while turning). It should be noted that the region of the rim part 20 in which the upper electrode 60U is arranged is also referred to as rim part upper part 20U hereinafter. The upper detection circuit 62U is connected with the upper electrode 60U via a wire 61U. The upper measurement circuit 62U measures the static capacitance between the upper electrode 60U and ground, as a value which varies according to the distance between the arrangement position of the upper electrode 60U and the human body. As the distance between the arrangement position of the upper electrode 60U and human body approaches, the static capacitance between the upper electrode 60U and ground increases. The measurement value Ch_U of static capacitance from the upper detection circuit 62U is sent to the grip determination device 60. It should be noted that the circuit configuration of the upper measurement circuit 62U is substantially the same as the right measurement circuit 62R shown in FIG. 2, and thus a detailed explanation is omitted.

The lower proximity sensor 6D includes a lower electrode 60D provided to the rim part 20, and a lower measurement circuit 62D electrically connected with this lower electrode 60D. The lower electrode 60D is a circular arc shape extending along the rim part 20, and is electrically conductive. The lower electrode 60D is provided at the inner side of the rim part 20. The lower electrode 60D is arranged in a range of about 90° between 135° and 225° of the rim part 20 (i.e. grippable range by right hand or left hand of driver while going straight, and range of the rim part 20 closest to knees of driver). It should be noted that the region of the rim part 20 in which the lower electrode 60D is arranged is also referred to as lower grip 20D hereinafter. The lower measurement circuit 62D is connected with the lower electrode 60D via a wire 61D. The lower measurement circuit 62D measures the static capacitance between the lower electrode 60D and ground as a value which varies according to the distance between the arrangement position of the lower electrode 60D and the human body. As the distance between the arrangement position of the lower electrode 60D and the human body approaches, the static capacitance between the lower electrode 60D and ground increases. The measurement value Ch_D of static capacitance from the lower detection circuit 62D is sent to the grip determination device 60. It should be noted that the circuit configuration of the lower measurement circuit 62D is substantially the same as the right measurement circuit 62R shown in FIG. 2, and thus a detailed explanation is omitted.

In the above way, the right electrode 60R of the right proximity sensor 6R is provided at a position closer to the right grip 20R than the other electrodes 60L, 60U, 60D. For this reason, the right proximity sensor 6R defines the right grip 20R of the rim part 20 as a detection target region. Therefore, in the case of the right grip 20R being gripped by the driver, or in the case of a foreign material having electrostatic capacitance such as a wet towel, portable information terminal, beverage container or the like contacting the right grip 20R, the measurement value Ch_R from the right proximity sensor 6R becomes larger than a predetermined right electrostatic capacitance threshold Ch_R_th.

The left electrode 60L of the left proximity sensor 6L is provided at a position closer to the left grip 20L than the other electrodes 60R, 60U, 60D. For this reason, the left proximity sensor 6L defines the left grip 20L of the rim part 20 as the detection target region. Therefore, in the case of the left grip 20L being gripped by the driver, or in the case of the above such foreign material having electrostatic capacitance such contacting the left grip 20L, the measurement value Ch_L from the left proximity sensor 6L becomes larger than a predetermined left electrostatic capacitance threshold Ch_L_th.

The upper electrode 60U of the upper proximity sensor 6U is provided at a position closer to the upper grip 20U than the other electrodes 60R, 60L, 60D. For this reason, the upper proximity sensor 6U defines the upper grip 200 of the rim part 20 as a detection target region. Therefore, in the case of the upper grip 20U being gripped by the driver, or in the case of the above such foreign material having electrostatic capacitance such contacting the upper grip 200, the measurement value Ch_U from the upper proximity sensor 6U becomes larger than a predetermined upper electrostatic capacitance threshold Ch_U_th.

The lower electrode 60D of the lower proximity sensor 6D is provided at a position closer to the lower grip 20D than the other electrodes 60R, 60L, 60U. For this reason, the lower proximity sensor 6D defines the lower grip 20D of the rim part 20 as a detection target region. Therefore, in the case of the lower grip 20D being gripped by the driver, or in the case of the above such foreign material having electrostatic capacitance contacting with the lower grip 20D, the measurement value Ch_D from the lower proximity sensor 6D becomes larger than the predetermined lower electrostatic capacitance value Ch_D_th.

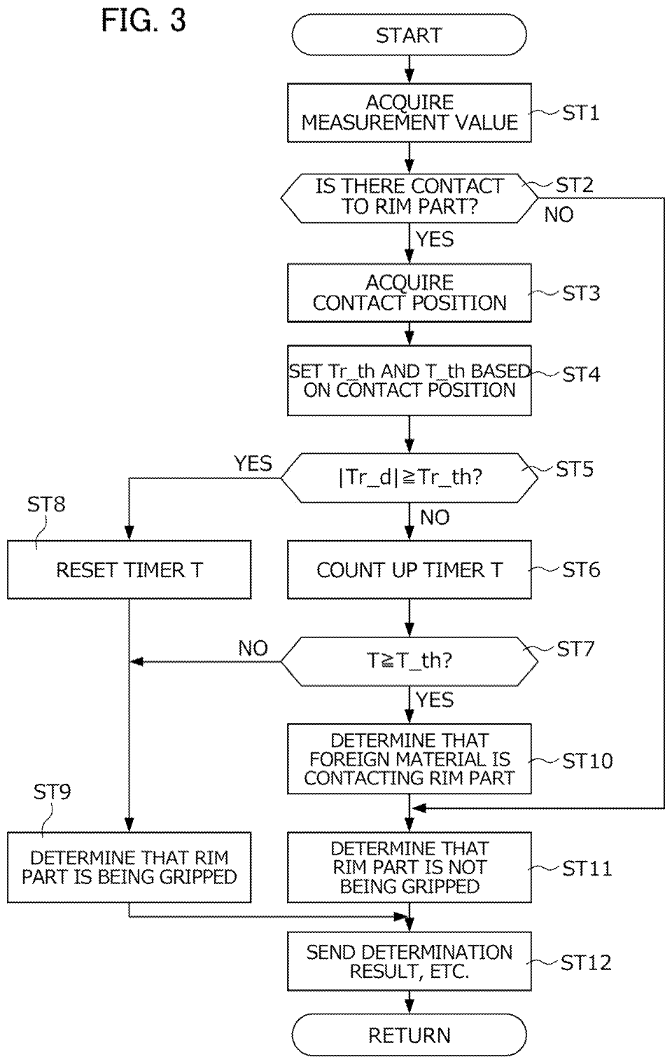

In the above way, the measurement values Ch_R, Ch_L, Ch_U, Ch_D of the proximity sensors 6R, 6L, 6U, 6D changes not only by gripping of the rim part 20 by the driver, but also by contact of a foreign material to the rim part 20, it is possible to accurately determine the presence/absence of gripping of the rim part 20 only by these measurement values Ch_R, Ch_L, Ch_U, Ch_D. Therefore, the grip determination device 60 determines the presence/absence of gripping of the rim part 20 by the driver, while distinguishing between contact of foreign material to the rim part 20 and contact of the hand of the driver, by executing grip determination processing explained below by referencing FIG. 3, based on the measurement values Ch_R, Ch_L, Ch_U, Ch_D acquired by the grip sensor unit 6 and the detection value Tr_d of the steering torque acquired by the torque sensor 31.

FIG. 3 is a flowchart showing a specific sequence of grip determination processing by the grip determination device 60. The processing shown in FIG. 3 is repeatedly executed under the predetermined control cycle of the grip determination device 60, in response to the vehicle being started by the driver operating a start switch (not shown).

First, in Step ST1, the grip determination device 60 acquires the measurement values Ch_R, Ch_L, Ch_U, Ch_D of electrostatic capacitance from the proximity sensors 6R, 6L, 6U, 6D, and then advances to Step ST2.

In Step ST2, the grip determination device 60 determines the presence/absence of contact of an object including a hand of the driver to the rim part 20 and the above such foreign material having electrostatic capacitance, based on the measurement values Ch_R, Ch_L, Ch_U, Ch_D acquired in Step ST 1. More specifically, the grip determination device 60 determines that an object is contacting the rim part 20, in the case of at least any of the measurement values the measurement values Ch_R, Ch_L, Ch_U, Ch_D being greater than the electrostatic capacitance threshold Ch_R_th, Ch_L_th, Ch_U_th, Ch_D_th. In addition, the grip determination device 60 determines that an object is not contacting the rim part 20 in the case of the measurement values Ch_R, Ch_L, Ch_U, Ch_D being no more than the electrostatic capacitance threshold Ch_R_th, Ch_L_th, Ch_U_th, Ch_D_th.

The grip determination device 60 advances to Step ST11 in the case of the determination result in Step ST2 being NO. In Step ST11, the grip determination device 60 determines that the rim part 20 is not being gripped by the driver, and then advances to Step ST12.

The grip determination device 60 advances to Step ST3 in the case of the determination result in Step ST2 being YES. In Step ST3, the grip determination device 60 acquires the contact position of the object to the rim part 20 based on the measurement values Ch_R, Ch_L, Ch_U, Ch_D acquired in Step ST1, and then advances to Step ST4. More specifically, with the grip determination device 60, the contact position of the object is established as being the right grip 20R in the case of the measurement value Ch_R being greater than the right electrostatic capacitance threshold Ch_R_th, the contact position of the object is established as being the left grip 20L in the case of the measurement value Ch_L being greater than the right electrostatic capacitance threshold Ch_L_th, the contact position of the object is established as being the upper grip 200 in the case of the measurement value Ch_U being greater than the upper electrostatic capacitance threshold Ch_U_th, and the contact position of the object is established as being the lower grip 20D in the case of the measurement value Ch_D being greater than the lower electrostatic capacitance threshold Ch_D_th.

In Step ST4, the grip determination device 60 sets the torque threshold Tr_th and time threshold T_th described later based on the contact position acquired in Step ST3, and then advances to Step ST5. More specifically, the grip determination device 60 sets the position farthest from the lower end 22 among the contact positions acquired in Step ST3 as the uppermost contact position, and sets the torque threshold Tr_th and time threshold T_th based on this uppermost contact position. It should be noted that the upper grip 200 is more distanced from the lower end 22 than the other grips 20R, 20L, 20D. The right grip 20R and left grip 20L are more distanced from the lower end 22 than the lower grip 20D. In addition, the distance between the right grip 20R and lower end 22 equals the distance between the left grip 20L and lower end 22.

It should be noted that the present embodiment explains a case of the grip determination device 60 changing both the torque threshold Tr_th and time threshold T_th based on the uppermost contact position. The grip determination device 60 may change only the torque threshold Tr_th based on the uppermost contact position, or may change only the time threshold T_th. In addition, the grip determination device 60 may set either the torque threshold Tr_th and time threshold T_th as a fixed value.

More specifically, the grip determination device 60 makes the torque threshold Tr_th smaller as the uppermost contact position approaches the lower end 22 of the rim part 20 (i.e. the torque threshold Tr_th is made to approach 0). In other words, in the case of the uppermost contact position being the lower grip 20D, the grip determination device 60 makes the torque threshold Tr_th smaller than a case of the uppermost contact position being the upper grip 200, right grip 20R or left grip 20L. In addition, in a case of the uppermost contact position being the right grip 20R or left grip 20L, the grip determination device 60 makes the torque threshold Tr_th smaller than a case of the uppermost contact position being the upper grip 20U.

There is a tendency of the magnitude of the steering torque generated in the case of the driver turning while gripping the rim part 20 becoming smaller as the gripping position by the driver approaches the lower end 22 seen from the driver of the rim part 20. Therefore, in the present embodiment, there are cases where it is possible to more precisely distinguish between contact of an object with the rim part 20 and contact of the hand of the driver, by making the torque threshold Tr_th smaller as the uppermost contact position approaches the lower end 22 of the rim part 20.

The grip determination device 60 lengthens the time threshold T_th as the uppermost contact position approaches the lower end 22 of the rim part 20. In other words, in a case of the uppermost contact position being the lower grip 20D, the grip determination device 60 lengthens the time threshold T_th more than a case of the uppermost contact position being the upper grip 20U, right grip 20R or left grip 20L. In addition, in the case of the uppermost contact position being the right grip 20R or left grip 20L, the grip determination device 60 lengthens the time threshold T_th more than a case of the uppermost contact position being the upper grip 20U.

The steering torque becomes more difficult to generate as the gripping position by the driver approaches the lower end 22 seen from the driver on the rim part 20. Therefore, in the present embodiment, there are cases where it is possible to more precisely distinguish between contact of an object to the rim part 20 and contact of the hand of the driver, by lengthening the time threshold T_th as the uppermost contact position approaches the lower end 22 of the rim part 20.

In the above way, the present embodiment explains a case of the grip determination device 60 making the torque threshold Tr_th smaller and lengthening the time threshold T_th, as the uppermost contact position approaches the lower end 22 of the rim part 20. The grip determination device 60 may make the torque threshold Tr_th larger or may shorten the time threshold T_th, as the uppermost contact position approaches the lower end 22 of the rim part 20. There are cases where it is thereby possible to prevent misjudging as being gripped erroneously, despite actually not being gripped.

In Step ST5, the grip determination device 60 determines whether the absolute value for the detection value Tr_d of the steering torque is at least the torque threshold Tr_th set in Step ST4. The grip determination device 60, in the case of the determination result in Step ST5 being NO, i.e. case of the absolute value for the detection value Tr_d of the steering torque being less than the torque threshold Tr_th, advances to Step ST6.

In Step ST6, the grip determination device 60 counts up (T←T+ΔT), by the control cycle ΔT, the timer T for measuring the time for which the absolute value for the detection value Tr_d of the steering torque was less than the torque threshold Tr_th, and then advances to Step ST7.

In Step ST7, the grip determination device 60 determines whether the timer T is at least the time threshold T_th. The grip determination device 60 advances to Step ST9 in the case of the determination result in Step ST7 being NO, and advances to Step ST10 in the case of being YES.

In addition, the grip determination device 60 advances to Step ST8 in the case of the determination result in Step ST5 being YES, i.e. the case of the absolute value for the detection value Tr_d of the steering torque being at least the torque threshold Tr_th. In Step ST8, the grip determination device 60 resets the timer T to the initial value (e.g., 0), and then advances to Step ST9.

In Step ST9, the grip determination device 60 determines that the rim part 20 is being gripped by the driver, and then advances to Step ST12. In the above way, the grip determination device 60 determines, in the case of detecting steering torque exceeding the torque threshold Tr_th after being determined that any object contacted the rim part 20 (refer to Steps ST2 and ST5), that the rim part 20 is being gripped with the contact position acquired in Step ST3 as the gripping position. In addition, the grip determination device 60 determines, in the case of the time for which the absolute value for the detection value Tr_d of the steering torque was less than the torque threshold Tr_th is less than the time threshold T_th after being determined that any object contacted the rim part 20 (refer to Steps ST2, ST5 and ST7), that the rim part 20 is being gripped temporarily with the contact position acquired in Step ST3 as the gripping position.

In Step ST10, the grip determination device 60 determines that a foreign material is contacting at the contact position acquired in Step ST3 on the rim part 20, and then advances to Step ST11. In addition, in Step ST11, the grip determination device 60 determines that the rim part 20 is not being gripped by the driver in the above way, and then advances to Step ST12. In the above way, the grip determination device 60 determines that the rim part 20 is not being gripped by the driver (refer to Step ST11), after determining that a foreign material is contacting at the contact position acquired in Step ST3 on the rim part 20 (refer to Step ST10), in the case of a state in which the absolute value for the detection value Tr_d of the steering torque is less than the torque threshold Tr_th continuing past the time threshold T_th (refer to Steps ST2, ST5, ST7, ST9), after determining that the rim part 20 is being gripped in response to any object contacting the rim part (refer to Step ST9).

In Step ST12, the grip determination device 60 sends information related to the determination result related to the presence/absence of gripping of the rim part 20 by the driver, information related to the gripping position, information related to the determination result of the presence/absence of contact of foreign material to the rim part 20, and information related to the contact position of the foreign material, to the controller group 8, and then returns to Step ST1.

Referring back to FIG. 1, the controller group 8 includes a notification device 81, safe driving ability evaluation device 82, and automatic driving device 83.

The notification device 81 generates support information for supporting safe driving by the driver based on the information related to the determination result for the presence/absence of gripping of the rim part 20, information related to the gripping position, information related to the determination result for the presence/absence of contact of foreign material to the rim part 20, and information related to the contact position of the foreign material sent from the grip determination device 60, and notifies the driver of the generated support information via an HMI (Human Machine Interface) (not shown) provided to the vehicle. More specifically, the notification device 81 notifies the driver through the sense of sight, sense of hearing, sense of touch or the like of the driver using the HMI, of the support information for prompting so as to grip the rim part 20 with the recommended grip position, in the case of determining that the driver is not gripping the rim part 20 with the grip determination device 60, or a case of the driver not gripping the rim part 20 at the recommended gripping position. In addition, in the case of being determined that foreign material is adhering to the rim part 20, the notification device 81 notifies the support information for prompting the removal of foreign material adhering to the rim part 20 together with support information for prompting so as to grip the rim part 20 at the recommended gripping position, using the HMI. In other words, the notification device 81 preferably prompts the driver to remove foreign material contacting the rim part 20 by changing the notification mode, between a case of being determined that the rim part 20 is not being gripped in response to all of the plurality of measurement values Ch_R, Ch_L, Ch_U, Ch_D being less than the electrostatic capacitance threshold (case of determination result in Step ST2 being NO), and case of determining that the rim part 20 is not being gripped in response to the state in which the absolute value for the detection value Tr_d of the steering torque is less than the torque threshold Tr_th continuing past the time threshold T_th (case of determination result in Step ST7 being YES), i.e. case of determining that foreign material is contacting the rim part 20.

The safe driving ability evaluation device 82 evaluates the safe driving ability of the driver, based on information related to the determination result for the presence/absence of gripping of the rim part 20 sent from the grip determination device 60, information related to the gripping position, information related to the determination result for the presence/absence of contact of a foreign material to the rim part 20, and information related to the contact position of the foreign material.

The automatic driving device 83 executes automatic driving control according to a plurality of automatic driving levels. In this case, the automatic driving device 83 changes the automatic driving level based on the information related to the determination result for the presence/absence of gripping of the rim part 20 sent from the grip determination device 60, or the information related to the determination result for the presence/absence of contact of a foreign material to the rim part 20.

According to the steering device 1 and safe driving aid system 9 according to the present embodiment, the following effects are exerted.

(1) When the driver grips the rim part 20 of the steering wheel 2, naturally when turning right and left, but even when driving straight, a slight amount of steering torque is generated intermittently

Therefore, the grip determination device 60 determines that a foreign material having electrical capacitance is contacting the rim part 20 of the steering wheel 2 in the case of the state in which the absolute value for the detection value Tr_d of the steering torque from the torque sensor 31 is less than the torque threshold Tr_th continuing past the time threshold T_th, after determining that the rim part 20 is being gripped based on the measurement values Ch_R, Ch_L, Ch_U and Ch_D for the electrostatic capacitance of the plurality of electrodes 60R, 60L, 60U, 60D provided to the steering wheel 2, i.e. case of significant steering torque not being detected over the time threshold T_th, and determines that the rim part 20 is not being gripped. Consequently, according to the steering device 1, it is possible to precisely determine the presence/absence of gripping of the rim part 20 by the driver, while distinguishing between contact of a foreign material to the rim part 20 and contact of the hand of the driver, and thus possible to contribute to the development of a sustainable transportation system. In addition, since the steering device 1 has no need to detect the heartbeat of the driver as mentioned above, it is possible to reduce the cost more than conventional.

(2) The magnitude of the steering torque generated in the case of the driver driving while gripping the rim part 20 differs according to the gripping position of the rim part 20.

Consequently, according to the steering device 1, it is possible to precisely distinguish between contact of foreign material to the rim part 20 and contact of the hand of the driver, by changing either or both of the torque threshold Tr_th and time threshold T_th based on the gripping position of the rim part 20 of the steering wheel 2.

(3) The safe driving support system 9 includes the steering device 1, and the controller group 8 which is communicably connected with the grip determination device 60 of this steering device 1. The controller group 8 can thereby support safe driving by the driver based on the determination results for the presence/absence of gripping of the rim part 20 and the determination result for the presence/absence of contact of a foreign material to the rim part 20 by the grip determination device 60, and thus possible to contribute to the development of a sustainable transportation system.

(4) The notification device 81 notifies the driver of information generated based on the determination result from the grip determination device 60. Since it is thereby possible to prompt appropriate gripping and prompt removal of foreign material to the driver, in the case of the driver not gripping the rim part 20 or a case of foreign material contacting the rim part 20, for example, it is possible to support safe driving by the driver.

(5) Since the notification device 81 can prompt appropriate gripping to the driver, and prompt removal of foreign material assumed to be contacting the rim part 20 to the driver, by changing the notification mode between a case of determining that the rim part 20 is not being gripped based on the measurement values Ch_R, Ch_L, Ch_U, Ch_D of electrostatic capacitance, and a case of determining that the rim part 20 is not being gripped in response to the state in which the absolute value for the detection value Tr_d of steering torque is less than the torque threshold Tr_th continuing past the time threshold T_th, it is possible to support safe driving by the driver.

(6) The safe driving ability evaluation device 82 evaluates the driving skill of the driver based on the determination result from the grip determination device 60. Since it is thereby possible to evaluate the driving ability by distinguishing between a case of the driver not appropriately gripping the rim part 20, and a case of a foreign material contacting the rim part 20, for example, it is possible to support safe driving by the driver.

(7) The automatic driving device 83 changes the automatic driving level based on the determination result from the grip determination device 60. Since it is thereby possible to change the automatic driving level by distinguishing between a case of the driver not gripping the rim part 20, and a case of a foreign material contacting the rim part 20, it is possible to support safe driving by the driver.

Although an embodiment of the present invention has been explained above, the present invention is not to be limited thereto. The configurations of detailed parts may be modified where appropriate within the scope of the gist of the present invention.

For example, in the above embodiment, the rim part 20 is divided into the four grips 20R, 20L, 200, 20D, and the grip sensor unit 6 determines the presence/absence of gripping of each grip 20R, 20L, 200, 20D based on the measurement values Ch_R, Ch_L, Ch_U, Ch_D for the electrostatic capacitance of each electrode 60R, 60L, 60U, 60D provided in the vicinity of each grip 20R, 20L, 20U, 20D; however, the present invention is not limited thereto. In other words, the position at which providing each electrode is not limited to the rim part 20, and may be providing to the spokes 25L, 25R, 25D or the hub part 23. In addition, the number of electrodes provided to the steering wheel 2 is not limited to four, and may be one to three, or five or more.

What is claimed is:

1. A steering device comprising:
a steering wheel which accepts a steering operation of a vehicle by a driver;
a torque sensor which detects steering torque acting on the steering wheel;
a measurement device which measures electrostatic capacitance of an electrode provided to the steering wheel; and
a grip determination device which determines presence/absence of gripping of the steering wheel,
wherein the grip determination device determines that the steering wheel is not being gripped in a case of, after determining that the steering wheel is being gripped based on a measurement result from the measurement device, a state in which an absolute value for a torque detection value from the torque sensor is less than a predetermined torque threshold continuing past a predetermined time threshold.

2. The steering device according to claim 1, wherein the grip determination device acquires a gripping position of the steering wheel based on the measurement result, and changes either one or both of the torque threshold and the time threshold based on the gripping position.

3. A safe driving support system comprising:
the steering device according to claim 1; and
a controller group communicably connected with the grip determination device.

4. The safe driving support system according to claim 3, wherein the controller group includes a notification device which notifies a driver of information generated based on a determination result from the grip determination device.

5. The safe driving support system according to claim 4, wherein the notification device changes a notification mode between a case of determining that the steering wheel is not being gripped based on the measurement result, and a case of determining that the steering wheel is not being gripped in response to the state in which the absolute value for the torque detection value is less than the torque threshold continuing past the time threshold.

6. The safe driving support system according to claim 3, wherein the controller group includes a safe driving ability evaluation device which evaluates a safe driving ability of the driver based on the determination result from the grip determination device.

7. The safe driving support system according to claim 3, wherein the controller group includes an automatic driving device which executes automatic driving control according to a plurality of automatic driving levels,
wherein the automatic driving device changes the automatic driving level based on a determination result from the grip determination device.

8. A safe driving support system comprising:
the steering device according to claim 2; and
a controller group communicably connected with the grip determination device.

9. The safe driving support system according to claim 8, wherein the controller group includes a notification device which notifies a driver of information generated based on a determination result from the grip determination device.

10. The safe driving support system according to claim 9, wherein the notification device changes a notification mode between a case of determining that the steering wheel is not being gripped based on the measurement result, and a case of determining that the steering wheel is not being gripped in response to the state in which the absolute value for the torque detection value is less than the torque threshold continuing past the time threshold.

11. The safe driving support system according to claim 8, wherein the controller group includes a safe driving ability evaluation device which evaluates a safe driving ability of the driver based on the determination result from the grip determination device.

12. The safe driving support system according to claim 8, wherein the controller group includes an automatic driving device which executes automatic driving control according to a plurality of automatic driving levels,
wherein the automatic driving device changes the automatic driving level based on a determination result from the grip determination device.
